(19) United States
(12) Patent Application Publication
(10) Pub. No.: US 2009/0293496 A1
(43) Pub. Date: Dec. 3, 2009

(54) GAS TURBINE ENGINES GENERATING ELECTRICITY BY COOLING COOLING AIR

(76) Inventors: James W. Norris, Lebanon, CT (US); James D. Hill, Tolland, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/131,280

(22) Filed: Jun. 2, 2008

(51) Int. Cl. F02C 6/04; F02C 7/12

(52) U.S. Cl. 60/782; 60/784; 60/806

(57) ABSTRACT

A portion of cooling air for cooling the turbine section of a gas turbine engine is tapped and passed through a heat exchanger. The portion of the cooling air is cooled in the heat exchanger, and the heat taken out of the portion of the cooling air is utilized to generate electricity.

### BACKGROUND OF THE INVENTION

The present invention relates to a ground-based turbine for generating electricity, wherein cooling air for the turbine sections is cooled in a generator and electricity is generated from the cooling step.

Ground based turbine systems are known and are utilized to generate electricity. Gas turbine engines generally include a compressor section compressing air and delivering the air into a combustion section at which it is mixed with fuel. The fuel and the air are combusted, and the products of this combustion are passed downstream over turbine rotors to drive the turbine rotors. The turbine rotors become quite hot, as the products of combustion are hot. Thus, it is known in the gas turbine industry to circulate cooling air through the turbine sections.

One main application for gas turbine engines are aviation-based uses. In such uses, the engines are cycled on and off relatively quickly (on the order of hours). One other application for gas turbine engines is the generation of electricity in ground-based uses. Such applications typically require the gas turbine engines to be operating for more constant and longer periods of time. Thus, ground-based turbine sections are subject to different challenges than air-based turbine sections. In particular, ground-based turbine sections are subject to creep life and oxidation limits.

It is known to cool various fluids, and utilize the cooling of those fluids to generate electricity. As an example, UTC-Power has a system known as the Pure Cycle®, which cools a fluid, and utilizes the energy captured from cooling the fluid to generate electricity.

### SUMMARY OF THE INVENTION

A gas turbine engine taps cooling air to be utilized in the turbine section. This cooling air is passed through a vapor cycle driven generator, and generates additional electricity while it is cooled. The cooled cooling air is re-introduced into the turbine section.

These and other features of the present invention can be best understood from the following specification and drawings, the following of which is a brief description.

### BRIEF DESCRIPTION OF THE DRAWINGS

FIG. 1 is a schematic view of a ground-based gas turbine engine incorporating a vapor cycle driven generator for cooling air.

FIG. 2 schematically shows an example vapor cycle driven generator.

### DETAILED DESCRIPTION OF THE PREFERRED EMBODIMENT

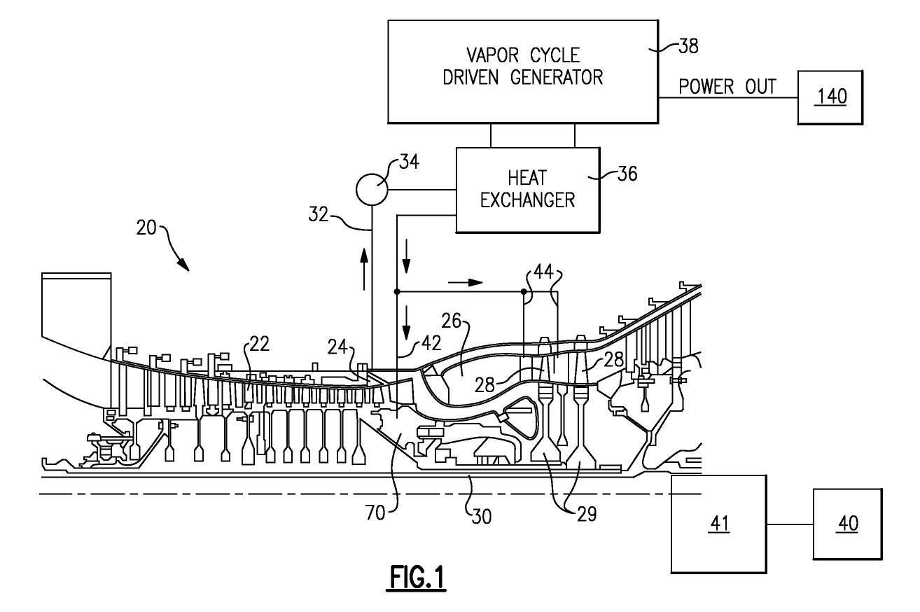

FIG. 1 shows a gas turbine engine 20 which is utilized in ground-based application. As known, air is compressed in compressor sections 22. This air is delivered downstream into a combustion section 26 where it is mixed with fuel and combusted. The products of combustion pass downstream over rotors 29 in turbine section 28, which are driven to rotate and power a shaft 30. As shown schematically, this shaft 30 drives compressor sections 22. As also shown, either the shaft 30 or a separate shaft driven by another turbine section drives a generator 41 for creating electricity for various uses 40. While one type ground-based electricity generation system is shown schematically, this application would extend to any type of generator for generating electricity utilizing a gas turbine engine. While a ground-based gas turbine engine for generating electricity is discussed, the invention can extend to other gas turbine engine applications.

As mentioned above, the turbine sections 28 are subject to high temperature from the products of combustion. Thus, it is typical to circulate a cooling fluid through the turbine section 28. A cooling fluid includes a portion of the air compressed by the compressor section 22, and may be delivered into a path 70 leading downstream toward the turbine section 28. While the cooling air in section 70 is cooler than the products of combustion, it is also heated relative to the ambient environment due to its compression in the compressor section 22. The present invention taps a portion of the cooling air from a discharge chamber 24 downstream of the compressor section 22 through a tap line or flow path 32 leading to a boost pump 34. This air is then delivered into a heat exchanger 36, where it is cooled by a vapor cycle driven generator 38. The cooling of the air creates electricity in the vapor cycle driven generator 38, and this electricity is delivered downstream to a use 140. The use 140 may be the same as the downstream use 40 of the generator 41, or may be some other auxiliary use. In one embodiment, less than 20%, and more narrowly 4-10% of the total cooling air is circulated through the heat exchanger, while the remainder is delivered directly into the combustion section. Downstream of the heat exchanger 36, the air passes back through lines 42 and 44 to perform its cooling functions.

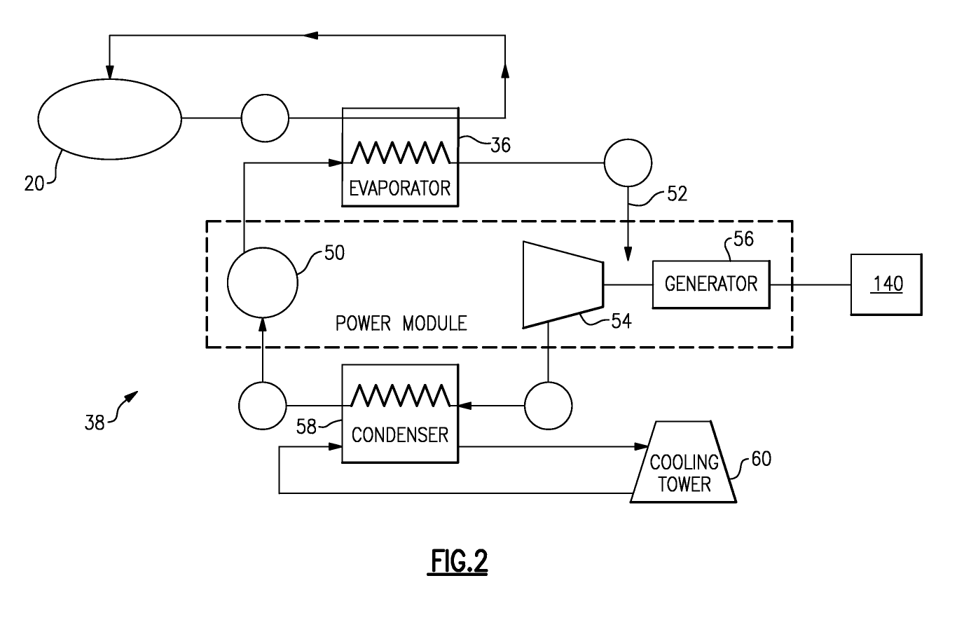

FIG. 2 shows one example vapor cycle driven generator 38. The vapor cycle driven generator 38 includes the heat exchanger 36 and the cooling air passing from the gas turbine engine 20 through the heat exchanger 36. A second fluid circulates through the heat exchanger 36, to cool the cooling air. This fluid passes into a line 52. The fluid in line 52 may be a refrigerant, or any other appropriate fluid that has good heat transfer characteristics. The fluid in line 52 has been elevated in pressure and heat by cooling the cooling air in the heat exchanger 36. This fluid now passes into a turbine section 54 that generates additional electricity in the generator 56. The fluid downstream of the turbine 54 passes through another heat exchanger 58, then to a pump 50, and back to the heat exchanger 36. Essentially, heat exchanger 36 functions as an evaporator and heat exchanger 58 functions as a condenser. A cooling tower 60 may circulated another fluid, such as cold water, through the heat exchanger 58 to cool the refrigerant prior to its being directed back to the heat exchanger 36.

The system as shown in FIG. 2 is generally known in the prior art as the Pure Cycle® system, and is available from UTC-Power of South Windsor, Conn. However, this system has never been utilized in combination with a gas turbine engine to cool cooling air, and extract additional electricity from that cooling air.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A gas turbine engine comprising:
a compressor section for delivering compressed air into a combustion section, and a turbine section for receiving products of combustion from the combustion section to cause rotation of rotors in the turbine section, and to drive the compressor section to rotate;
a flow path for passing cooling air from said compressor section and into said turbine section while bypassing the combustion section; and
a tap for tapping a portion of cooling air, and communicating said cooling air through a first heat exchanger, a second fluid in said first heat exchanger for cooling the cooling air in said first heat exchanger, and said second fluid then being utilized to generate electricity.

2. The gas turbine engine as set forth in claim 1, wherein said first heat exchanger and said second fluid are part of a vapor cycle driven generator.

3. The gas turbine engine as set forth in claim 2, wherein said second fluid passes from said first heat exchanger over a vapor cycle turbine to drive said vapor cycle turbine and generate electricity.

4. The gas turbine engine as set forth in claim 3, wherein said second fluid passes from said vapor cycle turbine through a second heat exchanger at which the second fluid is cooled.

5. The gas turbine engine as set forth in claim 1, wherein less than 20% of the cooling air ultimately delivered to the turbine sections is tapped.

6. The gas turbine engine as set forth in claim 5, wherein 4-10% of the cooling air delivered to the turbine section is tapped.

7. The gas turbine engine as set forth in claim 1, wherein a boost pump moves the tapped cooling air through the first heat exchanger.

8. A method of operating a ground-based gas turbine engine including the steps of:
(a) generating electricity from rotation of rotors in a turbine section;
(b) passing cooling air from a compressor section to cool components in said turbine section; and
(c) tapping a portion of the cooling air, and passing said cooling air through a first heat exchanger, a second fluid in said first heat exchanger cooling said cooling air in said first heat exchanger, and using said second fluid to generate electricity.

9. The method as set forth in claim 8, wherein said second fluid passes from said first heat exchanger over a vapor turbine to drive said turbine and generate electricity.

10. The method as set forth in claim 9, wherein said second fluid passes from the vapor turbine through a second heat exchanger at which the second fluid is cooled.

11. The method as set forth in claim 8, wherein less than 20% of the cooling air ultimately delivered to the turbine section is tapped.

12. The method as set forth in claim 11, wherein 4-10% of the cooling air delivered to the turbine section is tapped.

13. The method as set forth in claim 8, wherein a boost pump moves the tapped cooling air through the first heat exchanger.

14. A ground-based gas turbine engine comprising:
a compressor section for delivering compressed air into a combustion section, and a turbine section for receiving products of combustion from the combustion section to cause rotation of rotors in the turbine section;
a generator for generating electricity from rotation of said rotors in the turbine section;
a flow path for passing cooling air from said compressor section and into said turbine section while bypassing the combustion section; and
a tap for tapping a portion of cooling air, and communicating said cooling air through a first heat exchanger, a second fluid in said first heat exchanger for cooling the cooling air in said first heat exchanger, and said second fluid then being utilized to generate electricity.

15. The ground-based gas turbine engine as set forth in claim 14, wherein said first heat exchanger and said second fluid are part of a vapor cycle driven generator.

16. The ground-based gas turbine engine as set forth in claim 15, wherein said second fluid passes from said first heat exchanger over a vapor cycle turbine to drive said vapor cycle turbine and generate electricity.

17. The ground-based gas turbine engine as set forth in claim 16, wherein said second fluid passes from said vapor cycle turbine through a second heat exchanger at which the second fluid is cooled.

18. The ground-based gas turbine engine as set forth in claim 14, wherein less than 20% of the cooling air ultimately delivered to the turbine sections is tapped.

19. The ground-based gas turbine engine as set forth in claim 18, wherein 4-10% of the cooling air delivered to the turbine section is tapped.

20. The ground-based gas turbine engine as set forth in claim 14, wherein a boost pump moves the tapped cooling air through the first heat exchanger.
